(19) United States
(12) Patent Application Publication
(10) Pub. No.: US 2025/0069237 A1
(43) Pub. Date: Feb. 27, 2025

(54) METHOD AND APPARATUS FOR RECOGNITION OF A MOTION IN A VIDEO

(71) Applicant: SAMSUNG ELECTRONICS CO., LTD., Suwon-si (KR)

(72) Inventors: Vishakha S R, Karnataka (IN); Bindigan Hariprasanna Pawan Prasad, Bangalore (IN); Green Rosh K S, Kerala (IN); Akula Jayaprakash, Orissa (IN)

(73) Assignee: SAMSUNG ELECTRONICS CO., LTD., Suwon-si (KR)

(21) Appl. No.: 18/946,632

(22) Filed: Nov. 13, 2024

Related U.S. Application Data
(63) Continuation of application No. PCT/KR2023/006457, filed on May 12, 2023.

(30) Foreign Application Priority Data
May 13, 2022 (IN) 202241027759

(51) Int. Cl. G06T 7/246; G06T 3/18; G06T 7/70; G06V 40/20

(52) U.S. Cl. CPC G06T 7/246; G06T 3/18; G06T 7/70; G06V 40/23; G06T 2207/30241

(57) ABSTRACT

A method for recognizing an action of at least one object in a plurality of images, includes obtaining a plurality of image frames by capturing at least one object on a ground plane; detecting a motion of the at least one object and a motion of the ground plane in each of the plurality of image frames; estimating a trajectory of the ground plane by tracking the motion of the ground plane; correcting the motion of the at least one object in each of the plurality of image frames based on the trajectory of the ground plane; and recognizing an action of the at least one object based on the corrected motion of the at least one object.

### CROSS-REFERENCE TO RELATED APPLICATIONS

This application is a continuation of PCT International Application No. PCT/KR2023/006457, which was filed on May 12, 2023, and claims priority to Indian Patent Application No. 202241027759, filed on Apr. 20, 2023, and claims priority to Indian Patent Application No. 202241027759, filed on May 13, 2022, the disclosures of each of which are incorporated by reference herein their entirety.

### BACKGROUND

### 1. Field

The present embodiments relate to the field of image processing, and more specifically relates to a method and an apparatus for recognizing a subject action in a video.

### 2. Description of Related Art

Recognition of human body action in videos has become increasingly relevant in entertainment and multimedia applications in order to determine an action type of the human body action. With the rise of user-generated content, there is a growing demand for automated tools that can recognize human actions in a video (e.g., running, jumping, etc.) and can capture a snapshot of the best moment in the video (e.g., crossing finish line, high point of a jump, etc.). Such features may be used in a monitoring system used by federal agencies. The human body action in a video obtained by the monitoring system needs to be recognized to perceive the intention of the person in the video. Thus, in a man-machine interaction system, to understand a person's behavior in the video, the human body action needs to be recognized by the man-machine interaction system.

There are several challenges associated with existing image processing techniques for recognizing human body actions in a video, such as estimating a human posture to determine the human body action in the video. For example, estimating and tracking an arbitrary human posture from an image or a video sequence may be a challenging problem because it often involves variations in lighting, camera angles, and occlusions. Moreover, different actions may involve different body parts and may vary in speed and duration, making the task even more complex.

Several existing applications in a smartphone include a single take mode where multiple images and videos may be captured with one tap of a camera button associated with one or more cameras that are in-built into the smartphone. The camera may capture one or more images at frequent exposure intervals in a small time period, for example, 10 frames per second (fps), and then enhance the captured images so that a user can easily choose and share the best ones. Such single take mode applications may require accurate recognition of human body movements over multiple frames that are captured as images and videos. Existing techniques for recognizing human body movements typically rely on accurately estimating the posture of the human body to determine various human body key points.

### SUMMARY

According to an aspect of the disclosure, a method for recognizing an action of at least one object in a plurality of images comprise: obtaining a plurality of image frames by capturing at least one object on a ground plane; detecting a motion of the at least one object and a motion of the ground plane in each of the plurality of image frames; estimating a trajectory of the ground plane by tracking the motion of the ground plane; correcting the motion of the at least one object in each of the plurality of image frames based on the trajectory of the ground plane; and recognizing an action of the at least one object based on the corrected motion of the at least one object.

According to an aspect of the disclosure, the detecting the motion of the at least one object comprises: obtaining a plurality of key points of the at least one object in the plurality of image frames; and detecting the motion of the at least one object based on the plurality of key points.

According to an aspect of the disclosure, the estimating the trajectory of the ground plane comprises: identifying one or more coordinates of the ground plane of each of the plurality of image frames; obtaining a rotation value of the ground plane along at least one axis by using a rotation angle obtained in accordance with a trigonometrical function; obtaining a translation value of the ground plane based on the one or more coordinates of the ground plane; and estimating the trajectory of the ground plane based on the rotation value and translation value of the ground plane.

According to an aspect of the disclosure, the estimating the trajectory of the ground plane comprises: detecting a location and a boundary of a plane surface of the ground plane in each of the plurality of image frames; determining a motion of the plane surface based on a comparison of the location and the boundary of the plane surface in the plurality of image frames; and estimating a trajectory of the plane surface by tracking the motion of at least one object.

According to an aspect of the disclosure, the correcting the motion of the at least one object comprises: performing warping of at least one frame of the plurality of image frames along at least one axis based on the trajectory of the ground plane; obtaining a first correction value based on the warping, wherein the first correction value indicates shifting of the plurality of key points of the at least one object; and correcting the motion of the at least one object based on the first correction value; wherein the warping comprises transforming one or more geometric properties of at least one frame of the plurality of image frames.

According to an aspect of the disclosure, the correcting the motion of the at least one object comprises: detecting a location and a boundary of at least one static object in the plurality of image frames; estimating a trajectory of the at least one static object based on a comparison of the location and the boundary in the plurality of image frames; and correcting the motion of the at least one object in the plurality of image frames based on the estimated trajectory of the at least one static object.

According to an aspect of the disclosure, the correcting the motion of the at least one object comprises: estimating a trajectory of the at least one object based on the motion of the at least one object; obtaining a second correction value based on the trajectory of the object and the trajectory of the ground plane; and correcting the motion of the at least one object based on the second correction value.

According to an aspect of the disclosure, an electronic apparatus for recognizing an action of at least one object in a plurality of image frames of a video, the apparatus comprises: a memory, at least one processor communicably coupled to the memory, the at least one processor is configured to: obtain a plurality of image frames by capturing at least one object on a ground plane; detect a motion of the at least one object and a motion of the ground plane in each of the plurality of image frames; estimate a trajectory of the ground plane by tracking the motion of the ground plane; correct the motion of the at least one object in each of the plurality of image frames based on the trajectory of the ground plane; and recognize an action of the at least one object based on the corrected motion of the at least one object.

According to an aspect of the disclosure, the at least one processor is further configured, to detect the motion of the at least one object, to: obtain a plurality of key points of the at least one object in the plurality of image frames; and detect the motion of the at least one object based on the plurality of key points.

According to an aspect of the disclosure, the at least one processor is further configured, to estimate the trajectory of the ground plane, to: identify one or more coordinates of the ground plane of each of the plurality of image frames; obtain a rotation value of the ground plane along at least one axis by using a rotation angle obtained in accordance with a trigonometrical function; obtain a translation value of the ground plane based on the one or more coordinates of the ground plane; and estimate the trajectory of the ground plane based on the rotation value and translation value of the ground plane.

According to an aspect of the disclosure, the at least one processor is further configured, to estimate the trajectory of the ground plane, to: detect a location and a boundary of a plane surface of the ground plane in each of the plurality of image frames; determine the motion of the plane surface based on a comparison of the location and the boundary of the plane surface in the plurality of image frames; and estimate the trajectory of the plane surface by tracking the motion of at least one object.

According to an aspect of the disclosure, the at least one processor is further configured, to correct the motion of the at least one object, to: perform warping of at least one frame of the plurality of image frames along at least one axis based on the trajectory of the ground plane; obtain a first correction value based on the warping, wherein the first correction value indicates shifting of the plurality of key points of the at least one object; and correct the motion of the at least one object based on the first correction value, wherein the warping comprises transforming one or more geometric properties of at least one frame of the plurality of image frames.

According to an aspect of the disclosure, the at least one processor is further configured, to correct the motion of the least one object, to: detect a location and a boundary of at least one static object in the plurality of image frames; estimate a trajectory of the at least one static object based on a comparison of the location and the boundary in the plurality of image frames; and correct the motion of the at least one object in the plurality of image frames based on the estimated trajectory of the at least one static object.

According to an aspect of the disclosure, the at least one processor is further configured, to correct the motion of the at least one object, to: estimate a trajectory of the at least one object based on the motion of the at least one object; obtain a second correction value based on the trajectory of the object and the trajectory of the ground plane; and correct the motion of the at least one object based on the second correction value.

According to an aspect of the disclosure, a non-transitory computer readable medium having instructions stored therein, which when executed by a processor of a device cause the processor to execute a method comprising: obtaining a plurality of image frames by capturing at least one object on a ground plane; detecting a motion of the at least one object and a motion of the ground plane in each of the plurality of image frames; estimating a trajectory of the ground plane by tracking the motion of the ground plane; correcting the motion of the at least one object in each of the plurality of image frames based on the estimated trajectory of the ground plane; and recognizing an action of the at least one object based on the corrected motion of the at least one object.

To further clarify advantages and features of the disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

These and other features, aspects, and advantages of embodiments of the disclosure will become better understood when the following detailed description is read with reference to the accompanying drawings in which like characters represent like parts throughout the drawings.

FIG. 1 is a block diagram illustrating a standard motion recognition method for a subject in a video.

FIG. 2 illustrates a block diagram of an electronic apparatus for recognition of a motion of a subject in a plurality of image frames of a video, according to one or more embodiments.

FIG. 3 is a flow diagram illustrating a method for recognition of the motion of the subject in the plurality of image frames of the video, according to one or more embodiments.

FIG. 4 is a flow diagram illustrating the method for recognition of the motion of the subject in the plurality of image frames of the video, according to one or more embodiments.

FIG. 5 is a schematic flow diagram illustrating the method for correcting a body pose of the subject in each of the plurality of image frames of the video, according to one or more embodiments.

FIG. 6 illustrates an example use-case for creating a slow-motion video using recognition of the motion of the subject in the plurality of image frames of the video, according to one or more embodiments.

FIG. 7 illustrates an example use-case for creating a boomerang video using recognition of the motion of the subject in the plurality of image frames of the video, according to one or more embodiments.

FIG. 8 illustrates an example use-case for taking a snapshot of the best moment in a video using recognition of the motion of the subject in the plurality of image frames of the video, according to one or more embodiments.

FIG. 9 is a flow diagram illustrating the method for recognition of the motion of the subject in the plurality of image frames of the video, according to one or more embodiments.

Further, skilled artisans will appreciate those elements in the drawings are illustrated for simplicity and may not have necessarily been drawn to scale. For example, the flow charts illustrate the method in terms of the most prominent operations involved to help to improve understanding of aspects of embodiments of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the embodiments of the present disclosure, reference will now be made to the embodiment illustrated in the drawings and specific language will be used to describe the same. It will nevertheless be understood that no limitation of the scope of the embodiments of the present disclosure is thereby intended, such alterations and further modifications in the illustrated system, and such further applications of the principles of the embodiments of the present disclosure as illustrated therein being contemplated as would normally occur to one skilled in the art to which the embodiments of the present disclosure relate.

It will be understood by those skilled in the art that the foregoing general description and the following detailed description are explanatory of the embodiments of the present disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in one or more embodiments”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the embodiments of the present disclosure. Likewise, the blocks of the embodiments may be physically combined into more complex blocks without departing from the scope of the embodiments of the present disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

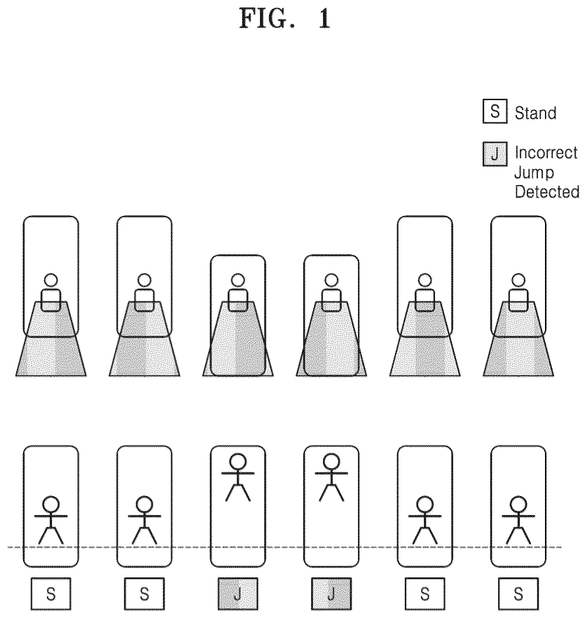

FIG. 1 is a block diagram illustrating a conventional motion recognition method for a subject in a video;

The conventional action recognition method may fail to recognize the human action accurately when the camera is in motion. For example, when a smartphone camera is in motion, the determination of the human key points may result in inaccurate recognition of the human action.

The camera may be in motion while capturing the video of the subject (human) standing on a ground. The camera may be moved in an up or down direction while capturing the video, and thus, may lead to a false action recognition of the subject. In this regard, even though the subject is standing still, movement of the camera may make it appear as if the subject is moving. The action may be incorrectly recognized or misclassified as a jump (J) while the subject, in reality, is standing (S) on the ground. Thus, accurate action recognition is very challenging when the camera capturing the subject itself is in motion.

Hence, it is desired to address the above-mentioned disadvantages or other shortcomings by providing a useful alternative for accurate recognition of the action of the subject in the video.

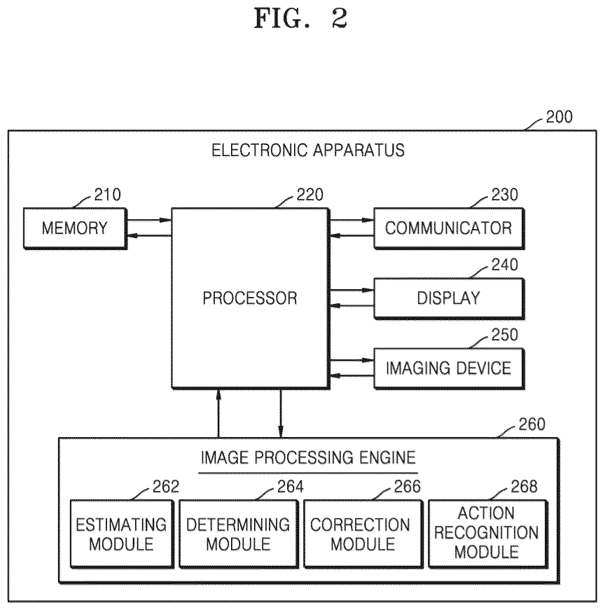

FIG. 2 illustrates a block diagram of an electronic apparatus 200 for recognition of a motion of a subject in a plurality of image frames of a video. Examples of the electronic apparatus 200 include, but not limited to, a smartphone, a tablet computer, a Personal Digital Assistance (PDA), an Internet of Things (IoT) configured electronic apparatus, a wearable device, or any other electronic apparatus capable of capturing, or processing images or video data.

According to one or more embodiments of the disclosure, the electronic apparatus 200 comprises a memory 210, a processor 220, a communicator 230, a display 240, an imaging device 250, and an image processing engine 260.

According to one or more embodiments of the disclosure, the memory 210 may store the video of the subject captured by the imaging device 250. In a non-limiting example, the plurality of image frames may be RGB frames indicating a sequence of frames captured and eventually displayed at a given frequency. However, by stopping at a specific frame of the sequence, a single video frame, i.e., an image, is obtained.

According to one or more embodiments of the disclosure, the memory 210 may store instructions to be executed by the processor 220 for recognition of a motion of a subject in the plurality of image frames of the video, as discussed herein throughout the disclosure.

According to one or more embodiments of the disclosure, the memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

According to one or more embodiments of the disclosure, the memory 210 maybe considered a non-transitory storage medium. The term “non-transitory” may indicate that the storage medium is not embodied in a carrier wave or a propagated signal. However, the term “non-transitory” should not be interpreted as the memory 210 is non-movable.

According to one or more embodiments of the disclosure, the memory 210 may be configured to store larger amounts of information than the memory.

According to one or more embodiments of the disclosure, a non-transitory storage medium may store data that can, over time, change (e.g., in Random Access Memory (RAM) or cache).

According to one or more embodiments of the disclosure, the memory 210 may be an internal storage unit, or it may be an external storage unit of the electronic apparatus 200, a cloud storage, or any other type of external storage.

The processor 220 may be configured to communicate with the memory 210, the communicator 230, the display 240, the imaging device 250, and the image processing engine 260.

According to one or more embodiments of the disclosure, the processor 220 may be configured to execute instructions stored in the memory 210 and may perform various processes to recognize the motion of the subject in the plurality of image frames of the video.

According to one or more embodiments of the disclosure, the processor 220 may include one or a plurality of processors, maybe a general-purpose processor, such as a central processing unit (CPU), an application processor (AP), or the like, a graphics-only processing unit such as a graphics processing unit (GPU), a visual processing unit (VPU), an Artificial intelligence (AI) dedicated processor such as a neural processing unit (NPU), or any other processing structure known to one of ordinary skill in the art.

In one or more examples, the communicator 230 may be configured for communicating internally between internal hardware components and with external devices (e.g., server, another electronic apparatus) via one or more networks (e.g., Radio technology). The communicator 230 may include an electronic circuit specific to a standard that enables wired or wireless communication, or any other communication circuitry known to one of ordinary skill in the art.

In one or more examples, the display 240 may be configured to provide a Graphical User Interface (GUI) for receiving one or more user inputs for recognizing the motion of the subject in the plurality of image frames of the video.

According to one or more embodiments of the disclosure, the display 240 may correspond to, but not limited to, made of a Liquid Crystal Display (LCD), a Light Emitting Diode (LED), an Organic Light Emitting Diode (OLED), or another type of display. The user input may include, but not limited to, a touch, swipe, drag, and gesture operation on the GUI.

In one or more examples, the imaging device 250 may include one or more image sensors (e.g., Charged Coupled Device (CCD), Complementary Metal-Oxide Semiconductor (CMOS)) to capture one or more images/image frames/video to be processed for recognition of the motion of the subject in the plurality of image frames of the video.

According to one or more embodiments of the disclosure, the imaging device 250 may not be present in the electronic apparatus 200 may process an image/video received from an external device or process a pre-stored image/video, without any deviation from the scope of the present disclosure.

In one or more examples, the image processing engine 260 may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

According to one or more embodiments of the disclosure, the image processing engine 260 may include an estimating module 262, a determining module 264, a correction module 266, and a motion recognition module 268, hereinafter collectively referred to as modules/units 262-268.

According to one or more embodiments of the disclosure, the image processing engine 260 and one or more modules/units 262-268 in conjunction with the processor 220 may perform one or more functions/methods, as discussed herein throughout the present disclosure.

According to one or more embodiments of the disclosure, the image processing engine 260 may be adapted to detect a user input indicative of a trigger to recognize the motion of the subject in the plurality of image frames of the video. The user input may include, for example, but not limited to, a request/instruction to recognize the motion in form of a swipe/touch/press gesture with a specific strength, a pen-based correction, a voice-based user input, etc.

In one or more examples, when the imaging device 250 captures the video of the subject, where the subject may be a human standing and posing for the video, the plurality of image frames in the video capturing the subject may be stored in the memory 210. As understood by one of ordinary skill in the art, the embodiments of the present disclosure are not limited to human subjects. For example, the embodiments of the present disclosure may use any desired subject as an object of an image such as a car, ball, pet, flying object, etc.

According to one or more embodiments of the disclosure, the image processing engine 260 detects a swipe gesture from left to right as an indication to recognize the motion of the subject in the plurality of image frames in the video. In one example, the motion is indicative of a movement performed by the subject while the video is captured. The motion may include unpredicted movements such as jumps, push-ups, running, etc.

In one or more examples, the estimating module 262 is adapted to estimate a body pose of the subject present in each of the plurality of image frames of the video.

According to one or more embodiments of the disclosure, the estimating module 262 is adapted to estimate a motion of the subject by a way of identifying and classifying the joints of the subject, preferably a human body. In one or more examples, a set of coordinates for each joint such as arm, head, torso, etc. may be detected and referred to as a key point. The key points on the human body or the subject may describe the motion of the subject. In general, a model-based technique may be used to represent and infer the motions of the subject in 2-dimensional and 3-dimensional space. When the plurality of image frames of the video is given to the estimating module 262 as input, the estimating module 262 detects the coordinates or key points related to the detected body parts of the subject in the plurality of image frames, as output thus estimating the motion of the subject based on the detected key points.

According to one or more embodiments of the disclosure, the determining module 264 may be adapted to determine a plane surface in the plurality of image frames of the video. The plane surface may be a ground plane surface on which the subject is situated, standing, or making the motion. The ground plane surface, for example, may be a floor, a ground, or a surface.

According to one or more embodiments of the disclosure, the determining module 264 may classify the static object and the subject based on comparing consecutive image frames. In one or more examples, the determining module 264 may calculate the correlation between consecutive image frames and determine the object as the static object in case that the calculated correlation is higher than other objects. In one or more examples, the determining module 264 may apply artificial intelligence techniques such as object classification. The embodiments of the present disclosure may utilize one or more neural networks that inputs an image or plurality of images and detects and classifies at least one object in the image(s). For example, a multi-layer perceptron (MLP), a convolutional neural network (CNN), or any other suitable neural network model may be used in the embodiments of the present disclosure.

According to one or more embodiments of the disclosure, the determining module 264 is further adapted to determine a trajectory of the plane surface and the subject, such that a ground-plane orientation with respect to the camera is determined. Thus, using the ground-plane orientation, the perspective distortion or warping may be performed to accurately recognize the motion of the subject.

According to one or more embodiments of the disclosure, the determining module 264 may adopt any known model-based technique, as known to an ordinary person skilled in the art to determine the plane surface in the plurality of image frames of the video. The model-based technique, includes, for example, artificial intelligence techniques including object classification or correlation analysis between consecutive image frames. In one or more examples, when the plurality of image frames of the video is given to the determining module 264 as input, the module 264 determines the plane surface present in each of the plurality of image frames.

According to one or more embodiments of the disclosure, the determining module 264 may be adapted to determine a normal vector for each plane present in each of the plurality of image frames. For example, each of the plurality of image frames may include a ground plane surface on which the subject is standing. Similarly, there may be other plane surface geometry such as a roof, or a wall in the plurality of image frames. Thus, the normal vector is determined for each of the plane surfaces. Further, when the normal vector is determined to be pointed upwards, the respective plane surface may be determined as the ground plane surface for further processing. Thereafter, the determining module 264 may be adapted to determine a location and a boundary of the ground plane surface in each of the plurality of image frames such that, the ground plane surface along with coordinates specifying boundaries, is identified in each of the plurality of image frames. The boundary of the ground plane may be specified as dimensions in two directions that are perpendicular to each other (e.g., X axis and Y axis).

According to one or more embodiments of the disclosure, the determining module 264 may be adapted to determine the trajectory of the plane surface in the plurality of image frames. The trajectory may be a path taken up by an object (the plane surface or the subject) that is following through space as a function of time. Mathematically, the trajectory is described as a position of the plane surface over the plurality of image frames denoting a time-period. Further, the trajectory may be denoted as a time series of points upon the plane surface recorded at equally spaced time-operations. These time series points may be determined within a coordinate system of the imaging device 250 through perspective back-projection.

According to one or more embodiments of the disclosure, the determining module 264 considers consecutive image frames, such as first frame (N−1)^{th} frame and a current frame (N^{th} frame) among the plurality of image frames, to determine the trajectory of the plane surface. The trajectory determination may signify the coordinates of the plane surface (or the ground plane surface) have translated from the (N−1)^{th} frame to the N^{th} frame. As understood by one of ordinary skill in the art, the plane surface (or the ground plane surface) may be static. Therefore, if the trajectory of the plane surface is determined to be moving upwards, it may signify that the electronic apparatus 200 capturing the video is moving downwards or vice-versa. In this regard, when it is assumed that the plane surface or the ground plane surface is static, movement of the plane surface or the ground plane surface may be correlated with movement of the camera.

According to one or more embodiments of the disclosure, the determining module 264 may be adapted to determine the trajectory of the ground plane surface to determine angles in which the plane surface has moved, and a translation of the plane surface as follows:

The co-ordinates of the plane surface are determined as shown in following equation:

Let plane at (N−1)^{th} frame be: a₁x+b₁y+c₁z=d₁

Let plane at N^{th} frame be: a₂x+b₂y+c₂z=d₂

In the above equation, the x, y, z parameters are the coordinates along the 3-axes.

In one or more examples, the a₁, b₁, c₁, d₁, a₂, b₂, c₂, d₂ parameters are arbitrary constant to represent a position of the plane surface in 3-axes.

Further, a rotation value of the plane surface along the 3-axes as shown in following equation (1-3) and a translation value of the plane surface may be determined as shown in following equation (4):

$$Rotation angle ( θ ) = {cos}^{- 1} ( \frac{{a}_{1} {a}_{2} + {b}_{1} {b}_{2} + {c}_{1} {c}_{2}}{\sqrt{{{a}_{1}}^{2} + {{b}_{1}}^{2} + {{c}_{1}}^{2}} \sqrt{{{a}_{2}}^{2} + {{b}_{2}}^{2} + {{c}_{2}}^{2}}} ) \qquad ( 1 )$$

Rotations value along x-axis:

$${R}_{x} ( θ ) = [ \begin{matrix}1 & 0 & 0 \\ 0 & cos θ & - s in θ \\ 0 & sin θ & cos θ\end{matrix} ] \qquad ( 2 )$$

Rotations value along y-axis:

$${R}_{y} ( θ ) = [ \begin{matrix}cos θ & 0 & s {ι}^{´} n θ \\ 0 & 1 & 0 \\ - s in θ & 0 & cos θ\end{matrix} ] \qquad ( 3 )$$

$$Translation value ( d ) = \vert \vert {d}_{2} - {d}_{1} \vert \vert \qquad ( 4 )$$

Thus, the trajectory of the plane surface in the first frame ((N−1)^{th} frame) and the current frame (N^{th} frame) among the plurality of image frames may be determined, in one or more examples, based on the rotation of the plane surface along the 3-axes and the translation of the plane surface.

According to one or more embodiments of the disclosure, the determining module 264 may determine a location and a bound of a static object present in the plurality of image frames.

According to one or more embodiments of the disclosure, the determining module 264 may further determine the trajectory of the static object in the plurality of image frames based on a comparison of the location and the bound in the plurality of image frames.

In one or more examples, the correction module 266 determines a correction value based on the determined trajectory of the plane surface.

According to one or more embodiments of the disclosure, the correction module 266 may be adapted to perform warping of at least one frame of the plurality of image frames along the 3-axes based on the determined trajectory of the plane surface such that geometric properties of the image frame are transformed. The warping may be indicative of how much the key points should be moved and in which direction to be moved in the current frame such that the motion of the subject is corrected.

The correction module 266 may be adapted to perform warping (W) along the 3-axes, and may be defined as shown in following equations (5-7):

$${W}_{x} = d * {R}_{x}^{- 1} ( θ ) \qquad ( 5 )$$

$${W}_{y} = d * {R}_{y}^{- 1} ( θ ) \qquad ( 6 )$$

$${W}_{z} = d * {R}_{z}^{- 1} ( θ ) \qquad ( 7 )$$

In one or more examples, the parameters Wₓ, W_{y}, W_{z} are warping value of x, y, and z axes respectively.

In one or more examples, the parameter d is the translation value.

In one or more examples, the parameters Rₓ⁻¹ (θ), R_{y}⁻¹ (θ), Rₓ⁻¹ (θ) are inverse matrices of rotation value along 3-axes respectively.

According to one or more embodiments of the disclosure, the correction module 266 may be adapted to determine the correction value in the motion of the subject based on the warping. The correction value may be indicative of shifting of the key points of the subject in the plurality of image frames, and may be defined as shown in following equation (8-10):

Let initial pose be: P=(Pₓ,P_{y}) (8)
wherein K=Camera matrix

In one or more examples, a corrected pose of x axis is:

$${{P}^{′}}_{x} = K \cdot {W}_{x} {P}_{x} \qquad ( 9 )$$

In one or more examples, a corrected pose of y axis is:

$${{P}^{′}}_{y} = K \cdot {W}_{y} {P}_{y} \qquad ( 10 )$$

Thus, the correction module 266 may be adapted to correct pose of N^{th} frame.

According to one or more embodiments of the disclosure, the motion recognition module 268 is adapted to recognize the motion based on the corrected motion of the N^{th} frame. A Deep Neural Network (DNN) may be trained for recognizing or detecting the motions from the corrected motion of N^{th} frame.

Although FIG. 2 shows various hardware components of the electronic apparatus 200, it is to be understood that other embodiments are not limited thereon. In other embodiments, the electronic apparatus 200 may include less or more number of components. Further, the labels or names of the components are used only for illustrative purposes and do not limit the scope of the embodiments of the present disclosure. One or more components may be combined to perform the same or substantially similar functions to recognize the motion of the subject in the plurality of image frames of the video.

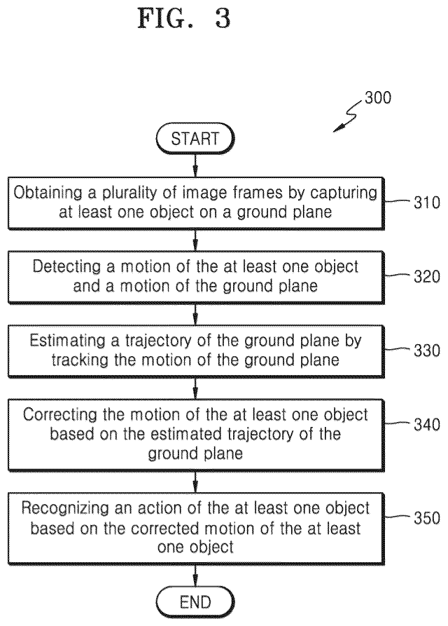

FIG. 3 is a flow diagram illustrating a method 300 for recognition of the motion of the subject in the plurality of image frames of the video. Operations 310 to operation 350 may be performed by the electronic apparatus 200 to recognize the motion of the subject in the plurality of image frames of the video.

At operation 310, the method 300 may include obtaining a plurality of image frames by capturing at least one object on a ground plane. According to one or more embodiments of the disclosure, the object may correspond to, but not be limited to, any subject or human standing or any static object present in the plurality of image frames of the video. The scene may be indicative of the plurality of image frames to be captured.

At operation 320, the method 300 may include detecting a motion of the at least one object and a motion of the ground plane.

At operation 330, the method 300 may include estimating a trajectory of the ground plane by tracking the motion of the ground plane.

At operation 340, the method 300 may include correcting the motion of the at least one object based on the estimated trajectory of the ground plane.

At operation 350, the method 300 may include recognizing an action of the at least one object based on the corrected motion of the at least one object.

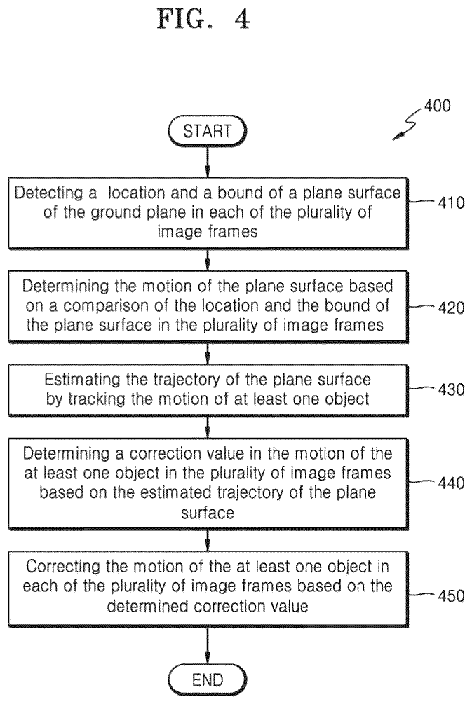

FIG. 4 is a flow diagram illustrating the method 400 for recognition of the motion of the subject in the plurality of image frames of the video. Operations 410 to operation 450 may be performed by the electronic apparatus 200 to recognize the motion of the subject in the plurality of image frames of the video. Operations 410 through 430 shown in FIG. 4 are details of operation 330 shown in FIG. 3. Operation 410 shown in FIG. 4 may be performed after performing operation 320 of FIG. 3. Operations 440 and 450 are details of operation 340 shown in FIG. 3. After performing operation 450 of FIG. 4, operation 350 of FIG. 3 may be performed.

At operation 410, the method 400 may include determining a location and a boundary of the plane surface in each of the plurality of image frames.

According to one or more embodiments of the disclosure, the method 400 may include determining the location and the boundary of the static object in the plurality of image frames. As the static object is also a stationary element similar to the plane surface, determining the trajectory of the static object may assist in recognizing the motion of the subject in the video.

According to one or more embodiments of the disclosure, the static object includes at least one of ground plane in the frame, a surface of the ground plane, or a boundary of the ground plane

At operation 420, the method 400 may include determining the motion of the plane surface based on a comparison of the location and the boundary of the plane surface in the plurality of image frames.

At operation 430, the method 400 may include estimating the trajectory of the plane surface by tracking the motion of at least one object.

According to one or more embodiments of the disclosure, the trajectory of the plane surface such as the ground surface is indicative of the movement of the plane surface in the plurality of image frames.

According to one or more embodiments of the disclosure, the method 400 may include determining the coordinates of the plane surface in each of the plurality of image frames.

According to one or more embodiments of the disclosure, the method 400 may include determining the rotation value of the plane surface along at least one axis and determining the translation value of the plane surface based on the coordinates of the plane surface in the current frame (N^{th} frame) and the first frame ((N−1)^{th} frame) in the plurality of image frames. Therefore, the determined rotation value and translation value may be correlated to determine the trajectory of the plane surface.

According to one or more embodiments of the disclosure, the method 400 may include determining the trajectory of the static object based on the comparison of the location and the boundary in the plurality of image frame similar to determining the trajectory of the plane surface.

According to one or more embodiments of the disclosure, the method 400 may include determining the trajectory of the at least one subject based on the estimated motion of the subject in each of the plurality of image frames. Thus, the initial pose of the subject in the first frame ((N−1)^{th} frame) may be determined.

At operation 440, the method 400 may include determining a correction value in the motion of the at least one object in the plurality of image frames based on the estimated trajectory of the plane surface.

According to one or more embodiments of the disclosure the method 400 may include performing warping of the plurality of image frames along the axis. In one or more examples, warping may comprise transforming one or more geometric properties of the plurality of image frames. Warping may be performed based on the determined trajectory of the plane surface.

According to one or more embodiments of the disclosure the correction value in the motion of the subject may be determined based on the warping. The correction value may be indicative of shifting of the key points of the subject in the current frame (N^{th} frame), when compared with the first frame ((N−1)^{th} frame).

At operation 450, the method 400 may include correcting the motion of the at least one object in each of the plurality of image frames based on the determined correction value such that the key points determined post warping may be applied to the current frame (N^{th} frame).

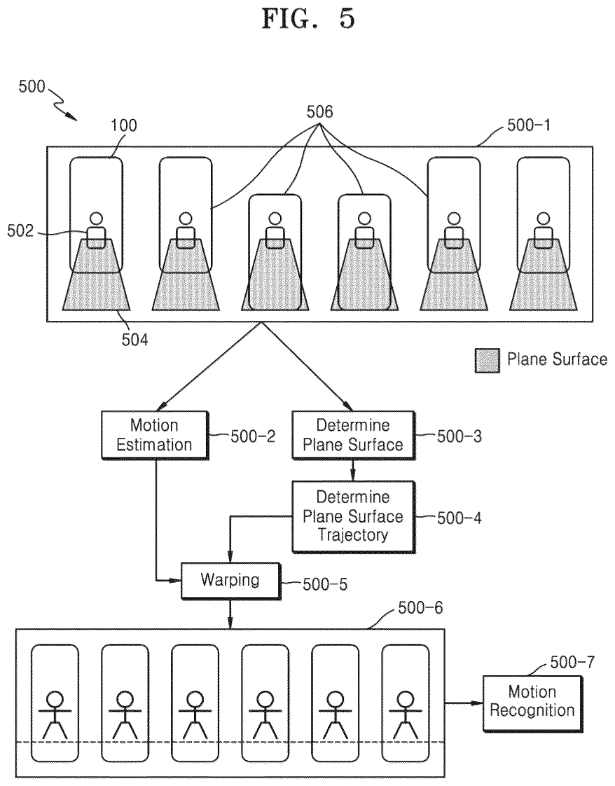

FIG. 5 is a schematic flow diagram illustrating the method for correcting a motion of the subject in each of the plurality of image frames of the video.

At operation 500-1, the method 500 may include the electronic apparatus 200 capturing the subject 502. The subject 502 may be standing on the ground plane surface 504. The electronic apparatus 200 may be configured to capture the plurality of image frames as illustrated at operation 500-1 while the electronic apparatus 200 is moved vertically up and down. Thus, the electronic apparatus 200 may be in motion while capturing the video of the subject 502 standing on the ground plane surface 504.

At operation 500-2, the method 500 may include estimating the motion of the subject.

At operation 500-3, the method 500 may include determining the ground plane surface 504 in each of the plurality of image frames.

At operation 500-4, the method 500 may include determining the trajectory of the ground plane surface 504 in the first frame (N−1^{th} frame) and the current frame (N^{th} frame) such that it provides the coordinates by which the ground plane surface 504 has rotated and translated between the first frame (N−1^{th} frame) and the current frame (N^{th} frame).

At operation 500-5, the method 500 may include performing warping based on the determined trajectory of the ground plane surface 504. The warping may comprise transforming one or more geometric properties of the current frame (N^{th} frame).

At operation 500-6, the method 500 may include correcting the motion of the subject 502 based on the warping such that the key points of the subject 502 may be shifted resulting in a corrected motion.

At operation 500-7, the method 500 may include recognizing the motion of the subject 502.

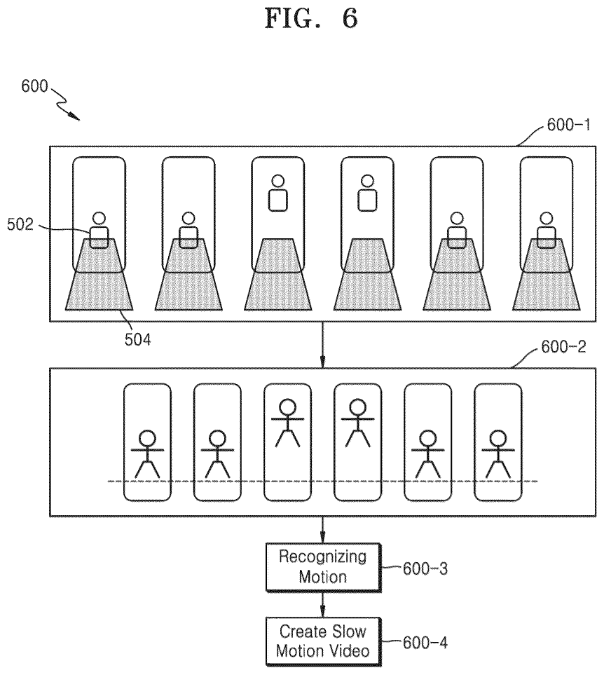

FIG. 6 illustrates an exemplary use-case for creating a slow-motion video using recognition of the motion of the subject 502 in the plurality of image frames of the video.

At operation 600-1, the method 600 may include capturing the plurality of image frames of the subject 502 in the video using the electronic apparatus 200. While capturing the plurality of image frames, the electronic apparatus 200 remains stable. However, the subject 502 may be performing a movement such as a jump. Thus, the ground plane surface 504 in the plurality of image frames may be determined, proceeded by determining the trajectory of the ground plane surface by comparing the N−1^{th} frame and the N^{th} frame.

At operation 600-2, the method 600 may include correcting the motion of the subject 502 with respect to the ground plane surface 504.

At operation 600-3, the method 600 may include recognizing the motion of the subject 502 as the jump based on the corrected motion.

At operation 600-4, the method 600 may include creating a slow-motion video after recognizing the motion of the subject 502 as the jump. The slow-motion video may indicate that a captured frame rate is slower than live-action captured by the electronic apparatus 200.

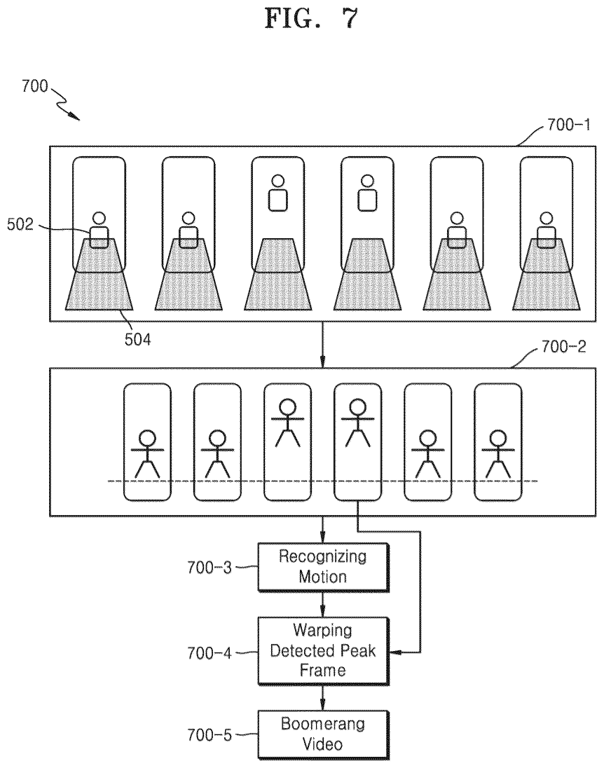

FIG. 7 illustrates an exemplary use-case for creating a boomerang video using recognition of the motion of the subject in the plurality of image frames of the video.

At operation 700-1, the method 700 may include capturing the plurality of image frames of the subject 502 in the video using the electronic apparatus 200. While capturing the plurality of image frames, the electronic apparatus 200 remains stable, however, the subject 502 may be performing a movement such as a jump. Thus, the ground plane surface 504 in the plurality of image frames may be determined, proceeded by determining the trajectory of the ground plane surface by comparing the N−1^{th} frame and the N^{th} frame.

At operation 700-2, the method 700 may include correcting the motion of the subject 502 with respect to the ground plane surface 504.

At operation 700-3, the method 700 may include recognizing the motion of the subject 502 as the jump based on the corrected motion.

At operation 700-4, the method 700 may include detecting a peak frame in the plurality of image frames. The peak frame may be predefined and is indicative of the motion in a peak form. Further, the method 700 may include warping the peak frame.

At operation 700-5, the method 700 may include displaying the warped peak frame to create a boomerang video.

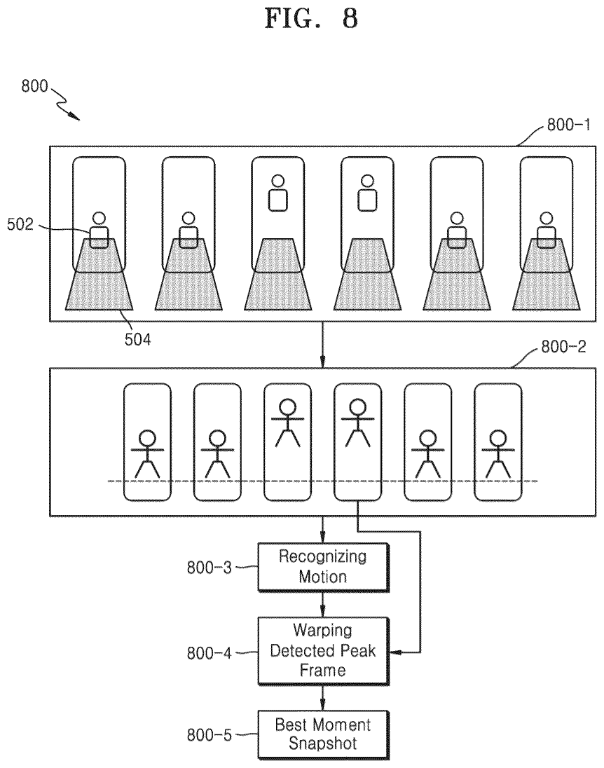

FIG. 8 illustrates an exemplary use-case for taking a snapshot of a best moment in a video using recognition of the motion of the subject in the plurality of image frames of the video.

At operation 800-1, the method 800 may include capturing the plurality of image frames of the subject 502 in the video using the electronic apparatus 200. While capturing the plurality of image frames, the electronic apparatus 200 remains stable. However, the subject 502 may be performing a movement such as a jump. Thus, the ground plane surface 504 in the plurality of image frames may be determined, proceeded by determining the trajectory of the ground plane surface by comparing the N−1^{th} frame and the N^{th} frame.

At operation 800-2, the method 800 may include correcting the motion of the subject 502 with respect to the ground plane surface 504.

At operation 800-3, the method 800 may include recognizing the motion of the subject 502 as the jump based on the corrected motion.

At operation 800-4, the method 800 may include detecting the peak frame in the plurality of image frames. The peak frame may be predefined and is indicative of the motion in a peak form. For example, the motion in the peak form may correspond to a high point of a jump, the completion of a throwing motion, etc. Further, the method 800 may include warping the peak frame.

At operation 800-5, the method 800 may include displaying the warped peak frame to capture a snapshot the peak frame among the plurality of image frames.

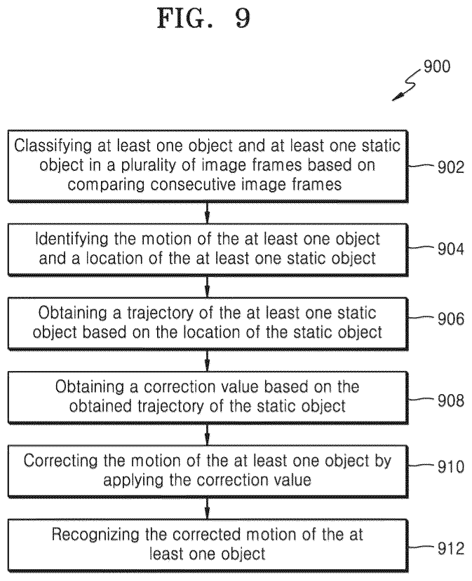

FIG. 9 is a flow diagram illustrating a method for recognition of the motion of the subject in the plurality of image frames of the video.

At operation 902, the method 900 may include classifying at least one object and at least one static object in a plurality of image frames based on comparing consecutive image frames.

According to one or more embodiments of the disclosure, the method 900 may include calculating a correlation between consecutive image frames and determining the object as the static object in case that the calculated correlation is higher than other objects.

According to one or more embodiments of the disclosure, the method 900 may include applying artificial intelligence techniques such as object classification for classifying at least one subject and at least one static object in the plurality of image frames.

The static object includes at least one of ground plane in the frame, a surface of the ground plane or a boundary of the ground plane. The static object may be a ground plane surface on which the subject is situated, standing, or making the motion. The ground plane surface is, for example, but not limited to, a floor, a ground, or a surface.

At operation 904, the method 900 may include identifying the motion of the at least one object and a location of the at least one static object

According to one or more embodiments of the disclosure, the method 900 may include estimating the motion of the subject by a way of identifying and classifying the joints of the subject, preferably a human body. A set of coordinates for each joint such as arm, head, torso, etc. may be detected and referred to as a key point. The key points on the human body or the subject may describe the motion of the subject. In general, a model-based technique may be used to represent and infer the motions of the subject in 2-dimensional and 3-dimensional space.

According to one or more embodiments of the disclosure, the method 900 may include detecting the coordinates or key points related to the detected body parts of the subject in the plurality of image frames, as output, thereby estimating the motion of the subject based on the detected key points.

According to one or more embodiments of the disclosure, the method 900 may include determining a normal vector for each plane present in each of the plurality of image frames. For example, each of the plurality of image frames may include a ground plane surface on which the subject is standing. In one or more examples, there may be other plane surface geometry such as a roof, or a wall in the plurality of image frames. Thus, the normal vector is determined for each of the plane surfaces. Further, when the normal vector is determined to be pointed upwards, the respective plane surface may be determined as the ground plane surface for further processing.

According to one or more embodiments of the disclosure, the method 900 may include determining a location and a boundary of the static object including ground plane surface in each of the plurality of image frames such that, the static object including ground plane surface along with coordinates specifying boundaries, is identified in each of the plurality of image frames.

At operation 906, the method 900 may include obtaining a trajectory of the at least one static object based on the location of the static object.

The trajectory may be a path taken up by an object (e.g., the plane surface or the subject) that is following through space as a function of time. In one or more examples, the trajectory may be defined as a position of the plane surface over the plurality of image frames denoting a time-period. Further, the trajectory may be denoted as a time series of points upon the plane surface recorded at equally spaced time-operations.

According to one or more embodiments of the disclosure, the method 900 may determining a trajectory of the plane surface and the subject, such that a ground-plane orientation with respect to the camera is determined. Thus, using the ground-plane orientation, the perspective distortion or warping may be performed to accurately recognize the motion of the subject. The trajectory of the plane surface such as the ground surface may be indicative of the movement of the plane surface in the plurality of image frames.

According to one or more embodiments of the disclosure, the method 900 may include determining the trajectory of the plane surface by considering consecutive image frames, such as first frame (N−1)^{th} frame and a current frame (N^{th} frame) among the plurality of image frames. The trajectory determination may signify the coordinates of the plane surface (or the ground plane surface) have translated from the (N−1)^{th} frame to the N^{th} frame. It may be apparent to an ordinary person skilled in the art that the plane surface (or the ground plane surface) is static. Therefore, if the trajectory of the plane surface is determined to be moving upwards, it may signify that the electronic apparatus 200 capturing the video is moving downwards or vice-versa.

According to one or more embodiments of the disclosure, the trajectory of the plane surface such as the ground surface is indicative of the movement of the plane surface in the plurality of image frames.

At operation 908, the method 900 may include obtaining a correction value based on the obtained trajectory of the static object.

According to one or more embodiments of the disclosure, the method 900 may include determining coordinates of the plane surface in each of the plurality of image frames.

According to one or more embodiments of the disclosure, the method 900 may include determining the rotation value of the plane surface along at least one axis and determining the translation value of the plane surface based on the coordinates of the plane surface in the current frame (N^{th} frame) and the first frame ((N−1)^{th} frame) in the plurality of image frames. Thus, the determined rotation value and translation value may be correlated to determine the trajectory of the plane surface.

According to one or more embodiments of the disclosure, the method 900 may include determining the trajectory of the static object based on the comparison of the location and the boundary in the plurality of image frame similar to determining the trajectory of the plane surface.

According to one or more embodiments of the disclosure, the correction value may include the rotation value or translation value.

According to one or more embodiments of the disclosure, the method 900 may include performing warping of at least one frame of the plurality of image frames along the 3-axes based on the determined trajectory of the plane surface such that geometric properties of the image frame are transformed. The warping may indicate how much the key points should be moved and in which direction to be moved in the current frame such that the motion of the subject is corrected.

According to one or more embodiments of the disclosure the correction value in the motion of the subject is determined based on the warping. The correction value may indicate shifting of the key points of the subject in the current frame (N^{th} frame), when compared with the first frame ((N−1)^{th} frame).

According to one or more embodiments of the disclosure, the method 900 may include determining the correction value in the motion of the subject based on the warping.

At operation 910, the method 900 may include correcting the motion of the at least one object by applying the correction value.

At operation 912, the method 900 may include recognizing the corrected motion of the at least one object.

According to one or more embodiments of the disclosure, the method 900 may include recognizing the motion based on the corrected subject motion of the N^{th} frame. A Deep Neural Network (DNN) may be trained for recognizing or detecting the motions from the corrected motion of N^{th} frame.

According to one or more embodiments of the disclosure, the method may include obtaining a plurality of image frames by capturing at least one object on a ground plane.

According to one or more embodiments of the disclosure, the method may include detecting a motion of the at least one object and a motion of the ground plane in each of the plurality of image frames.

According to one or more embodiments of the disclosure, the method may include estimating a trajectory of the ground plane by tracking the motion of the ground plane.

According to one or more embodiments of the disclosure, the method may include correcting the motion of the at least one object in each of the plurality of image frames based on the estimated trajectory of the ground plane.

According to one or more embodiments of the disclosure, the method may include recognizing the action of the at least one object based on the corrected motion of the at least one object.

According to one or more embodiments of the disclosure, the method may include obtaining a plurality of key points of the at least one object in the plurality of image frames.

According to one or more embodiments of the disclosure, the method may include detecting the motion of the at least one object based on the plurality of key points.

According to one or more embodiments of the disclosure, the method may include identifying coordinates of the ground plane of each of the plurality of image frames.

According to one or more embodiments of the disclosure, the method may include obtaining a rotation value of the ground plane along at least one axis by using a rotation angle obtained by trigonometrical function.

According to one or more embodiments of the disclosure, the method may include obtaining a translation value of the ground plane based on the coordinates of the ground plane.

According to one or more embodiments of the disclosure, the method may include estimating the trajectory of the ground plane based on the obtained rotation value and translation value of the ground plane.

According to one or more embodiments of the disclosure, the method may include detecting a location and a boundary of a plane surface of the ground plane in each of the plurality of image frames.

According to one or more embodiments of the disclosure, the method may include determining a motion of the plane surface based on a comparison of the location and the boundary of the plane surface in the plurality of image frames.

According to one or more embodiments of the disclosure, the method may include estimating a trajectory of the plane surface by tracking the motion of at least one object.

According to one or more embodiments of the disclosure, the method may include performing warping of at least one frame of the plurality of image frames along at least one axis based on the trajectory of the ground plane.

According to one or more embodiments of the disclosure, the method may include obtaining a first correction value based on the warping, wherein the first correction value indicates shifting of the plurality of key points of the at least one subject.

According to one or more embodiments of the disclosure, the method may include correcting the motion of the at least one object based on the first correction value.

According to one or more embodiments of the disclosure, warping indicates transforming geometric properties of at least one frame of the plurality of image frames.

According to one or more embodiments of the disclosure, the method may include detecting a location and a boundary of at least one static object in the plurality of image frames.

According to one or more embodiments of the disclosure, the method may include estimating a trajectory of the at least one static object based on a comparison of the location and the boundary in the plurality of image frames.

According to one or more embodiments of the disclosure, the method may include correcting the motion of the at least one object in the plurality of image frames based on the estimated trajectory of the at least one static object.

According to one or more embodiments of the disclosure, the method may include estimating a trajectory of the object based on the motion of the object.

According to one or more embodiments of the disclosure, the method may include obtaining a second correction value based on the trajectory of the object and the trajectory of the ground plane.

According to one or more embodiments of the disclosure, the method may include correcting the motion of the at least one object based on the second correction value.

According to one or more embodiments of the disclosure, the method may include detecting, by an imaging device, a motion of at least one object in a scene to be captured.

According to one or more embodiments of the disclosure, the method may include detecting a motion of a ground plane in the vicinity of the at least one object in the scene.

According to one or more embodiments of the disclosure, the method may include determining the motion of the ground plane by tracking trajectory of the motion of the ground plane.

According to one or more embodiments of the disclosure, the method may include applying the determined motion of the ground plane to compensate for shake or motion of the imaging device during capture, for estimating the motion of the at least one object in the scene.

According to one or more embodiments of the disclosure, the method may include causing to trigger post motion camera functions by applying the estimated motion of the object in the scene.

According to one or more embodiments of the disclosure, the ground plane includes at least one static object in the scene.

According to one or more embodiments of the disclosure, the trajectory of the plane surface is indicative of a movement of the plane surface in the plurality of image frames.

According to one or more embodiments of the disclosure, the method may include recognizing the action of the at least one subject based on the corrected body pose.

According to one or more embodiments of the disclosure, the method may include creating a slow-motion video using the plurality of image frames in response to recognizing the action.

According to one or more embodiments of the disclosure, the electronic apparatus may include a memory and at least one processor communicably coupled to the memory.

According to one or more embodiments of the disclosure, at least one processor is configured to obtain a plurality of image frames by capturing at least one object on a ground plane.

According to one or more embodiments of the disclosure, at least one processor is configured to detect a motion of the at least one object and a motion of the ground plane in each of the plurality of image frames.

According to one or more embodiments of the disclosure, at least one processor is configured to estimate a trajectory of the ground plane by tracking the motion of the ground plane.

According to one or more embodiments of the disclosure, at least one processor is configured to correct the motion of the at least one object in each of the plurality of image frames based on the estimated trajectory of the ground plane.

According to one or more embodiments of the disclosure, at least one processor is configured to recognize the action of the at least one object based on the corrected motion of the at least one object.

According to one or more embodiments of the disclosure, at least one processor is configured to obtain a plurality of key points of the at least one object in the plurality of image frames.

According to one or more embodiments of the disclosure, at least one processor is configured to detect the motion of the at least one object based on the plurality of key points.

According to one or more embodiments of the disclosure, at least one processor is configured to identify coordinates of the ground plane of each of the plurality of image frames.

According to one or more embodiments of the disclosure, at least one processor is configured to obtain a rotation value of the ground plane along at least one axis by using a rotation angle obtained by trigonometrical function.

According to one or more embodiments of the disclosure, at least one processor is configured to obtain a translation value of the ground plane based on the coordinates of the ground plane.

According to one or more embodiments of the disclosure, at least one processor is configured to estimate the trajectory of the ground plane based on the obtained rotation value and translation value of the ground plane.

According to one or more embodiments of the disclosure, at least one processor is configured to detect a location and a boundary of a plane surface of the ground plane in each of the plurality of image frames.

According to one or more embodiments of the disclosure, at least one processor is configured to determine the motion of the plane surface based on a comparison of the location and the boundary of the plane surface in the plurality of image frames.

According to one or more embodiments of the disclosure, at least one processor is configured to estimate the trajectory of the plane surface by tracking the motion of at least one object.

According to one or more embodiments of the disclosure, at least one processor is configured to perform warping of at least one frame of the plurality of image frames along at least one axis based on the trajectory of the ground plane.

According to one or more embodiments of the disclosure, at least one processor is configured to obtain a first correction value based on the warping, wherein the first correction value indicates shifting of the plurality of key points of the at least one subject.

According to one or more embodiments of the disclosure, at least one processor is configured to correct the motion of the at least one object based on the first correction value.

According to one or more embodiments of the disclosure, warping indicates transforming geometric properties of at least one frame of the plurality of image frames.

According to one or more embodiments of the disclosure, at least one processor is configured to detect a location and a boundary of at least one static object in the plurality of image frames.

According to one or more embodiments of the disclosure, at least one processor is configured to estimate a trajectory of the at least one static object based on a comparison of the location and the boundary in the plurality of image frames.

According to one or more embodiments of the disclosure, at least one processor is configured to correct the motion of the at least one object in the plurality of image frames based on the estimated trajectory of the at least one static object.

According to one or more embodiments of the disclosure, at least one processor is configured to estimate a trajectory of the object based on the motion of the object.

According to one or more embodiments of the disclosure, at least one processor is configured to obtain a second correction value based on the trajectory of the object and the trajectory of the ground plane.

According to one or more embodiments of the disclosure, at least one processor is configured to correct the motion of the at least one object based on the second correction value.

According to one or more embodiments of the disclosure, at least one processor is configured to detect a motion of at least one object in a scene to be captured.

According to one or more embodiments of the disclosure, at least one processor is configured to detect a motion of a ground plane in the vicinity of the at least one object in the scene.

According to one or more embodiments of the disclosure, at least one processor is configured to determine the motion of the ground plane by tracking trajectory of the motion of the ground plane.

According to one or more embodiments of the disclosure, at least one processor is configured to apply the determined motion of the ground plane to compensate for shake or motion of the imaging device during capture, for estimating the motion of the at least one object in the scene.

According to one or more embodiments of the disclosure, at least one processor is configured to cause to trigger post motion camera functions by applying the estimated motion of the object in the scene.

According to one or more embodiments of the disclosure, the ground plane includes at least one static object in the scene.

According to one or more embodiments of the disclosure, a computer readable medium containing at least one instruction that, when executed, causes at least one processor of a device to perform operations corresponding to the method.

Disclosed herein is a method for an enhanced motion estimation of an object in imaging. The method includes detecting, by an imaging device, a motion of at least one object in a scene to be captured. The method further includes detecting a motion of a static object in the vicinity of the at least one object in the scene. The method further includes determining the motion of the static object by tracking trajectory of the motion of the static object and applying the determined motion of the static object to compensate for shake or motion of the imaging device during capture, for estimating the motion of the at least one object in the scene.

Also, disclosed herein is a method for recognition of a motion of a subject in a plurality of image frames of a video. The method includes estimating a body pose of at least one subject present in each of the plurality of image frames. The method further includes determining a location and a boundary of a plane surface in each of the plurality of image frames. The method further includes determining a trajectory of the plane surface based on a comparison of the location and the boundary of the plane surface in the plurality of image frames. The method includes determining a trajectory of the at least one subject based on the estimated body pose in each of the plurality of image frames. Thereafter, the method includes determining a correction value in the body pose in the plurality of image frames based on the trajectory of the plane surface. The method further includes correcting the body pose of the at least one subject in each of the plurality of image frames based on the determined correction value and recognizing the motion of the at least one subject based on the corrected body pose.

In addition, disclosed herein is an apparatus for recognition of a motion of a subject in a plurality of image frames of a video. The apparatus includes a memory and at least one processor communicably coupled to the memory. The at least one processor is configured to estimate a body pose of at least one subject present in each of the plurality of image frames. The at least one processor is further configured to determine a location and a boundary of a plane surface in each of the plurality of image frames. The at least one processor is further configured to determine a trajectory of the plane surface based on a comparison of the location and the boundary of the plane surface in the plurality of image frames. The at least one processor is further configured to determine a trajectory of the at least one subject based on the estimated body pose in each of the plurality of image frames. Further, the at least one processor is configured to determine a correction value in the body pose in the plurality of image frames based on the trajectory of the plane surface. The at least one processor is further configured to correct the body pose of the at least one subject in each of the plurality of image frames based on the determined correction value and recognize the motion of the at least one subject based on the corrected body pose.

To further clarify the advantages and features of the present embodiments of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The embodiments of the disclosure will be described and explained with additional specificity and detail in the accompanying drawings.

A method for an enhanced motion estimation of an object in imaging is disclosed. The method includes detecting, by an imaging device 250, a motion of at least one object in a scene to be captured. The method includes detecting a motion of a ground plane in the vicinity of the at least one object in the scene. The method further includes determining the motion of the ground plane by tracking trajectory of the motion of the ground plane and applying the determined motion of the ground plane to compensate for shake or motion of the imaging device 250 during capture, for estimating the motion of the at least one object in the scene.

What is claimed is:

1. A method for recognizing an action of at least one object in a plurality of images, the method comprising:
obtaining a plurality of image frames by capturing at least one object on a ground plane;
detecting a motion of the at least one object and a motion of the ground plane in each of the plurality of image frames;
estimating a trajectory of the ground plane by tracking the motion of the ground plane;
correcting the motion of the at least one object in each of the plurality of image frames based on the trajectory of the ground plane; and
recognizing the action of the at least one object based on the corrected motion of the at least one object.

2. The method of claim 1, wherein the detecting the motion of the at least one object comprises:
obtaining a plurality of key points of the at least one object in the plurality of image frames; and
detecting the motion of the at least one object based on the plurality of key points.

3. The method of claim 1, wherein the estimating the trajectory of the ground plane comprises:
identifying one or more coordinates of the ground plane of each of the plurality of image frames;
obtaining a rotation value of the ground plane along at least one axis by using a rotation angle obtained in accordance with a trigonometrical function;
obtaining a translation value of the ground plane based on the one or more coordinates of the ground plane; and
estimating the trajectory of the ground plane based on the rotation value and translation value of the ground plane.

4. The method of claim 1, wherein the estimating the trajectory of the ground plane comprises:
detecting a location and a boundary of a plane surface of the ground plane in each of the plurality of image frames;
determining a motion of the plane surface based on a comparison of the location and the boundary of the plane surface in the plurality of image frames; and
estimating a trajectory of the plane surface by tracking the motion of at least one object.

5. The method of claim 1, wherein the correcting the motion of the at least one object comprises:
performing warping of at least one frame of the plurality of image frames along at least one axis based on the trajectory of the ground plane;
obtaining a first correction value based on the warping, wherein the first correction value indicates shifting of the plurality of key points of the at least one object; and
correcting the motion of the at least one object based on the first correction value;
wherein the warping comprises transforming one or more geometric properties of at least one frame of the plurality of image frames.

6. The method of claim 1, wherein the correcting the motion of the at least one object comprises:
detecting a location and a boundary of at least one static object in the plurality of image frames;
estimating a trajectory of the at least one static object based on a comparison of the location and the boundary in the plurality of image frames; and
correcting the motion of the at least one object in the plurality of image frames based on the estimated trajectory of the at least one static object.

7. The method of claim 1, wherein the correcting the motion of the at least one object comprises:
estimating a trajectory of the at least one object based on the motion of the at least one object;
obtaining a second correction value based on the trajectory of the object and the trajectory of the ground plane; and
correcting the motion of the at least one object based on the second correction value.

8. An electronic apparatus for recognizing an action of at least one object in a plurality of image frames of a video, the apparatus comprises:
a memory;
at least one processor communicably coupled to the memory, the at least one processor being configured to:
obtain a plurality of image frames by capturing at least one object on a ground plane;
detect a motion of the at least one object and a motion of the ground plane in each of the plurality of image frames;
estimate a trajectory of the ground plane by tracking the motion of the ground plane;
correct the motion of the at least one object in each of the plurality of image frames based on the trajectory of the ground plane; and
recognize the action of the at least one object based on the corrected motion of the at least one object.

9. The apparatus of claim 8, wherein the at least one processor is further configured, to detect the motion of the at least one object, to:
obtain a plurality of key points of the at least one object in the plurality of image frames; and
detect the motion of the at least one object based on the plurality of key points.

10. The apparatus of claim 8, wherein the at least one processor is further configured, to estimate the trajectory of the ground plane, to:
identify one or more coordinates of the ground plane of each of the plurality of image frames;
obtain a rotation value of the ground plane along at least one axis by using a rotation angle obtained in accordance with a trigonometrical function;
obtain a translation value of the ground plane based on the one or more coordinates of the ground plane; and
estimate the trajectory of the ground plane based on the rotation value and translation value of the ground plane.

11. The apparatus of claim 8, wherein the at least one processor is further configured, to estimate the trajectory of the ground plane, to:
detect a location and a boundary of a plane surface of the ground plane in each of the plurality of image frames;
determine the motion of the plane surface based on a comparison of the location and the boundary of the plane surface in the plurality of image frames; and
estimate the trajectory of the plane surface by tracking the motion of at least one object.

12. The apparatus of claim 8, wherein the at least one processor is further configured, to correct the motion of the at least one object, to:
perform warping of at least one frame of the plurality of image frames along at least one axis based on the trajectory of the ground plane;
obtain a first correction value based on the warping, wherein the first correction value indicates shifting of the plurality of key points of the at least one object; and
correct the motion of the at least one object based on the first correction value,
wherein the warping comprises transforming one or more geometric properties of at least one frame of the plurality of image frames.

13. The apparatus of claim 8, wherein the at least one processor is further configured, to correct the motion of the least one object, to:
detect a location and a boundary of at least one static object in the plurality of image frames;
estimate a trajectory of the at least one static object based on a comparison of the location and the boundary in the plurality of image frames; and
correct the motion of the at least one object in the plurality of image frames based on the estimated trajectory of the at least one static object.

14. The apparatus of claim 8, wherein the at least one processor is further configured, to correct the motion of the at least one object, to:
estimate a trajectory of the at least one object based on the motion of the at least one object;
obtain a second correction value based on the trajectory of the object and the trajectory of the ground plane; and
correct the motion of the at least one object based on the second correction value.

15. A non-transitory computer readable medium having instructions stored therein, which when executed by a processor of a device cause the processor to execute a method comprising:
obtaining a plurality of image frames by capturing at least one object on a ground plane;
detecting a motion of the at least one object and a motion of the ground plane in each of the plurality of image frames;
estimating a trajectory of the ground plane by tracking the motion of the ground plane;
correcting the motion of the at least one object in each of the plurality of image frames based on the estimated trajectory of the ground plane; and
recognizing an action of the at least one object based on the corrected motion of the at least one object.
